(19) United States
(12) Patent Application Publication
(10) Pub. No.: US 2013/0235564 A1
(43) Pub. Date: Sep. 12, 2013

(54) ARCHITECTURAL MOLDING SYSTEM

(71) Applicants: Karina Barcelos, Brandon, FL (US); Robert Karnick, Tampa, FL (US); Chris Stefko, St. Petersburg, FL (US)

(72) Inventors: Karina Barcelos, Brandon, FL (US); Robert Karnick, Tampa, FL (US); Chris Stefko, St. Petersburg, FL (US)

(21) Appl. No.: 13/791,191

(22) Filed: Mar. 8, 2013

Related U.S. Application Data
(60) Provisional application No. 61/609,097, filed on Mar. 9, 2012.

(51) Int. Cl. F21V 33/00

(52) U.S. Cl. CPC F21V 33/006
USPC 362/151

(57) ABSTRACT

The invention provides an architectural molding system including at least one section of molding that comprises an elongated body having a longitudinally extending light clip channel and a longitudinally extending slot through a front surface of the elongated body and communicating with the longitudinally extending light clip channel. The longitudinally extending slot is downwardly and outwardly sloped in a direction from the longitudinally extending light clip channel towards the bottom of the front surface. A flexible light source, such as, a rope light is removably postionable within the light clip channel. When the light source is turned on the longitudinally extending slot directs the light from the light clip channel upon a floor surface adjacent the molding.

### CROSS-REFERENCE TO RELATED APPLICATIONS

This application claims the benefit of U.S. Provisional Application No. 61/609,097, filed Mar. 9, 2012, the entirety of which is incorporated herein by reference.

### FIELD OF THE INVENTION

The present invention relates generally to architectural moldings for covering the joint between a wall surface and a floor surface or for covering the joint between a wall surface and a ceiling surface, and more particularly, relating to such architectural moldings commonly referred to as baseboards or crown moldings which incorporate one or more channels for retaining a rope lighting fixture for illuminating the wall, floor and/or ceiling surface to which the molding is mounted.

### BACKGROUND OF THE INVENTION

Architectural moldings such as baseboards (skirting board) and crown molding are old and well known. These moldings are available in a myriad of ornamental and decorative designs to compliment a particular décor and to satisfy personal preference. Despite a number of improvements that have been made of the years to the methods of manufacturing and installing such architectural moldings, there remains a need for an improved architectural molding that may be used with surface coverings such as interlocking pavers and which may be illuminated to provide various aesthetically pleasing light effects.

### SUMMARY OF THE INVENTION

Embodiments of the present invention provide an architectural molding system for both baseboard and crown molding applications that includes a plurality of inter-connectable elements that are connected together to form a continuous molding structure.

Embodiment of the present invention also provide an architectural molding system that is constructed for application with interlocking pavers and the like and includes a paver edge channel for receiving the edges of pavers at the junction between the ground and wall surfaces which serves to conceal gaps between the pavers and the wall, and which further serves to aid in retaining the molding system and the pavers.

Embodiments of the present invention also provide an architectural molding system that is configurable for application with various different types of floor surfaces including pavers, ceramic tile hardwood and the like.

Embodiments of the present invention also provide an architectural molding system that for providing illumination to a building interior or exterior either in a baseboard application or a crown molding application with channels designed specifically for receiving and retaining therein ropes lights.

In a specific application, an embodiment of the present invention includes an elongated molding (trim) section of a unitary extrusion of a suitable material that includes an upper and lower light rope receiving channel that extends the entire length of the section.

Further, in a specific application, an embodiment of the present invention includes an elongated molding (trim) section of a unitary extrusion of a suitable material that includes a channel for receiving a flooring or ground covering material, such as pavers, that may be removed from the section according to a desired application.

To achieve these and other advantages, in general, in one aspect, an architectural molding is provided. The molding includes an elongated body of a unitary extrusion of suitable material, upper and lower rope light clip channels extending the entire length of the body and a flooring channel extending the entire length of the body. The body further includes a substantially flat back surface for mounting to a wall, and an opposed decorative front surface. The upper rope light clip channel is rearwardly opening and is semi-circular shaped for the purpose of frictionally receiving and retaining a light rope therein along the length of the body. The lower rope light clip channel is generally downwardly and forwardly opening and is semi-circular shaped for the purpose of frictionally receiving and retaining a light rope therein along the length of the body. The flooring channel is defined by upper and lower forwardly projecting legs that are connected at a rearward side by a vertical web.

To achieve these and other advantages, in general, in another aspect, an architectural molding system is provided. The architectural molding system includes at least one section of molding that comprises an elongated body having a longitudinally extending light clip channel and a longitudinally extending slot through a front surface of the elongated body and communicating with the longitudinally extending light clip channel. The longitudinally extending slot is downwardly and outwardly sloped in a direction from the longitudinally extending light clip channel towards the bottom of the front surface.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a perspective, in-use environmental view of an architectural molding system constructed in accordance with the principles of an embodiment the present invention;

FIG. 2 is a perspective view of a linear molding section constructed in accordance with the principles of an embodiment of the present invention;

FIG. 3 is a cross-section view taken along line 3-3 of FIG. 1;

FIG. 4 is a perspective view of a linear molding section constructed in accordance with the principles of an embodiment of the present invention shown in an alternative configuration from the configuration illustrated in FIG. 2;

FIG. 5 is a cross-sectional view illustrating the linear molding section of FIG. 4;

FIG. 6 is a diagrammatic view of an outside corner coupling for joining the ends of two molding sections that meet at an inside corner between two wall surfaces;

FIG. 7 is a diagrammatic view of an inside corner coupling for joining the ends of two molding sections that meet at an outside corner between two wall surfaces;

FIG. 8 is a diagrammatic view of a straight coupling for joining the ends of two molding sections that meet along a common wall surface;

FIG. 9 is a diagrammatic view of an end cap for terminating the end of a molding section for the purpose of providing a finished end;

FIG. 10 is a partial cross-sectional view of a rectangular support column having mounted thereon the architectural molding system of the present invention in accordance with an embodiment thereof;

FIG. 11 is a partial cross-sectional view of a circular support column having mounted thereon the architectural molding system of the present invention in accordance with an embodiment thereof; and

FIG. 12 is a transverse cross-section of a molding section according to an alternative embodiment of the present invention.

### DETAILED DESCRIPTION OF THE INVENTION

As a preliminary matter, it should be noted that in this document (including the claims) directional terms, such as “above”, “below”, “upper”, “lower”, etc., are used for convenience in referring to the accompanying drawings. Additionally, it is to be understood that the various embodiments of the invention described herein may be utilized in various orientations, such as inclined, inverted, horizontal, vertical, etc., without departing from the principles of the invention.

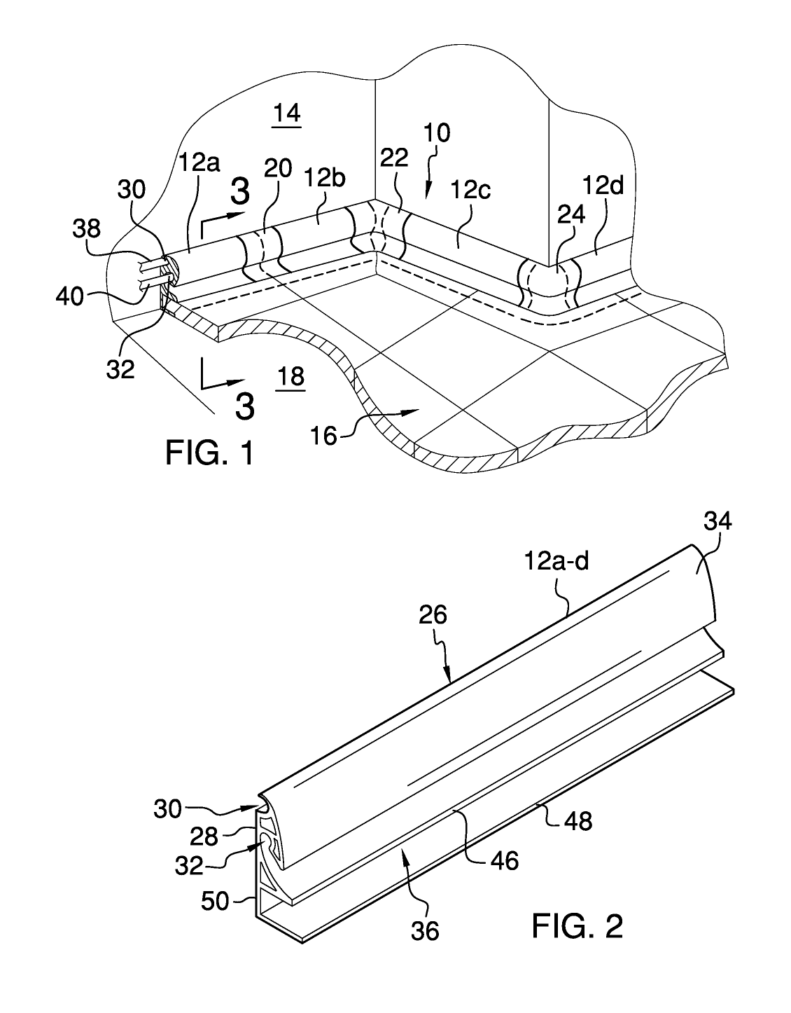

With reference now to FIG. 1 of the drawings, there is illustrated an architectural molding system 10 embodying the principals and concepts of the present invention. As depicted here, the architectural molding system 10 is configured as a baseboard and is mounted to wall 14 along the interface or joint between the wall and a floor surface covering 16 that is laid over a subfloor surface 18. The wall 14 is an exterior wall of a building and floor surface covering 16 is comprised of interlocking pavers; however, the invention is not limited to this configuration.

As depicted in FIG. 1, a plurality of molding sections 12a-d are mounted to wall 14 and are joined end-to-end by couplings 20, 22 and 24. Of course one of ordinary skill in the art will readily appreciate that the system 10 may utilize more elements than what is shown in the partial and exemplary depiction of FIG. 1, which is a simplified illustration for the purpose of understanding the present invention. While it is not shown, sections 12a-d are mounted to wall 14 by a suitable construction adhesive. Alternatively, and possibly less desirable, sections 12a-d may be fastened to the wall surface using fasteners such as nails, brads, screws, etc.

Coupling 20 is a straight coupling for connecting together the confronting ends of molding sections, such as molding sections 12a and 12b that are mounted to a common wall surface. Coupling 22 is an inset corner coupling for connecting together the ends of molding sections that meet at an inside corner, such as molding sections 12b and 12c. Coupling 24 is an outside corner coupling for connecting together the ends of molding sections that meet at an outside corner, such as molding sections 12c and 12d.

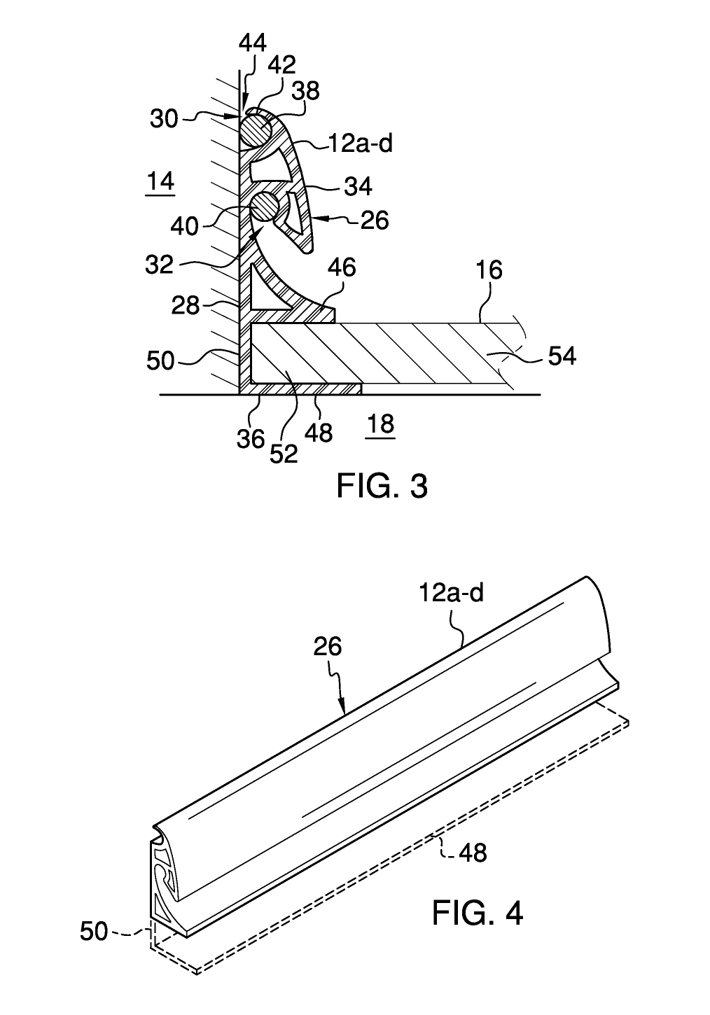

With continued reference to FIG. 1 along with further reference to FIGS. 2 and 3, each molding section, for example molding sections 12a-d is a unitary extrusion formed from a suitable plastic, rubber or rubberized material. In an embodiment, molding sections are a unitary extrusion formed from a suitable material that permits some form of curving the molding section around a curved wall surface.

Molding section 12a-d includes a horizontally elongated body 26 having a substantially flat back surface 28, longitudinally extending upper and lower rope light clip channels 30 and 32, a decorative front side 34, and a longitudinally extending, and forwardly opening flooring channel 36. Back surface 26 is substantially flat to interface with wall 14, and may be textured to permit better bonding with an adhesive used to mount body 26 to the wall.

The upper rope light clip channel 30 is rearwardly opening and extends the entire length of body 26. Further, the upper rope light clip channel 30 has a continuous semi-circular cross-section for frictionally receiving and retaining therein a rope light, such as rope light 38. As best seen in FIG. 3, the upper leg 42 of the upper rope light clip channel 30 stops short of wall 14, thereby forming a small gap 44 between the body 26 and the wall. The lower light clip channel 32 is generally forwardly and downwardly opening and extends the entire length of body 26. Similarly, the lower rope light clip channel 26 has a continuous semi-circular cross-section for frictionally receiving and retaining therein a rope light, such as rope light 40.

Rope light 38 and 40 extend the upper and lower rope light clip channels 30 and 32, respectively of interconnected molding sections 12a-d, thereby extending the length of the architectural molding system 10. When illuminated, rope light 38 back lights wall 14 through gap 44, and rope light 40 illuminates the floor surface 16 along the length of the molding section. For the purpose of herein, rope light means a string of light bulbs, light emitting diodes or other light source within a solid or hollow tube of flexible material.

Flooring channel or in the depicted example, paver channel 36 is defined by upper and lower forwardly projecting legs 46, 48 that are connected at the rearward side of body 26 by vertical web 50. Channel 36 has a generally C-shaped cross-section as defined by projecting legs 46, 48 and vertical web 50, and is sized to receive therein an edge 52 of paver 54. This arrangement advantageously helps to retain positioning of both the molding section 12a-d and of the paver 54. Further, leg 46 conceals gaps between the paver and wall 14 that otherwise would be visible. It is contemplated that body 26 may be formed of a suitable material that is sufficiently ridged such that an adhesive is not required for mounting to wall 14, and rather the body is simply retained in position by a paver inserted into channel 36.

In certain applications, it may be advantageous to eliminate channel 36, for example when using the architectural molding system 10 with an alternative flooring material, such as hard woods floors, ceramic tile and the like, or when using the architectural molding system in a crown molding application as opposed to a baseboard application. Accordingly, and with reference to FIG. 4, channel 36 may be eliminated by detaching web 50 along with leg 48 from the remaining portion of body 26. In embodiments, body 26 may be formed from a material that can be cut with a conventional utility knife, and in such embodiments, the body may be cut along the top web 50. In other embodiments, the body 26 may be formed from a material suitable for cutting with a power saw, such as a table saw or the like. In embodiments, body 26 may be formed with a provision, such as, for example a groove, perforation, serration or the like to permit breaking of web 50 from the body 26. Alternatively, the body 12 may be initially formed without channel 36.

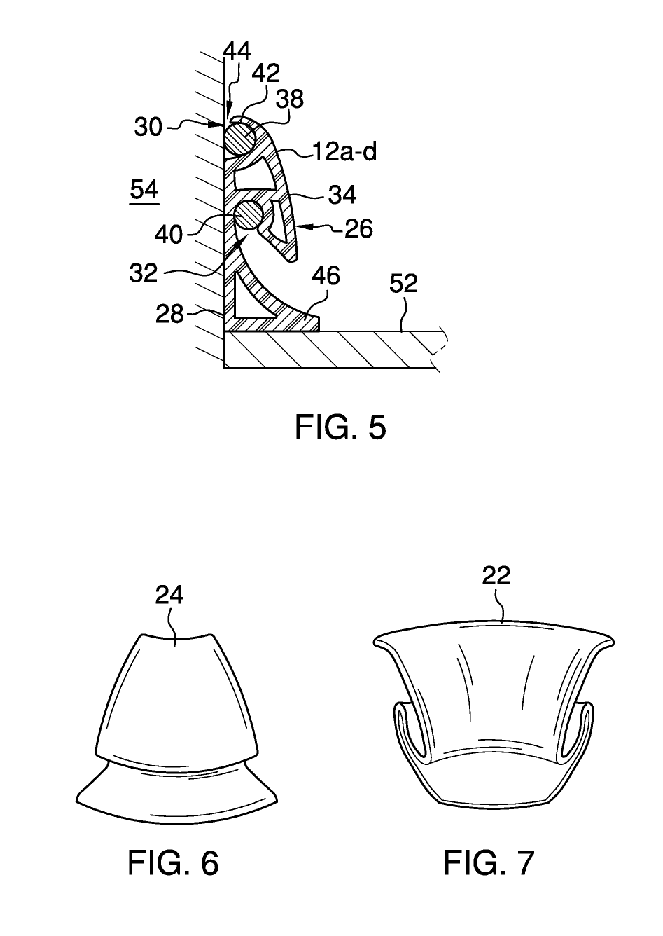

With reference to FIG. 5, there is a cross-sectional view, similar to FIG. 3, illustrating an application of the architectural molding system 10 with channel 36 removed from body 26 of molding section 12a-d. As depicted here, flooring is comprised of ceramic tile or hardwood 52. Molding section 12a-d is attached to wall 54 by a suitable construction adhesive (not shown). Alternatively, and possibly less desirable, sections 12a-d may be fastened to the wall surface using fasteners such as nails, brads, screws, etc. Similar to the prior discussed application made with reference to FIGS. 1 through 3, leg 46 advantageously conceals gaps between the flooring material 52 and the wall 54.

In FIG. 6 there is illustrated an outside corner coupling 24 used for joining together the adjacent ends of two molding sections that meet at an inside corner.

In FIG. 7 there is illustrated an inside corner coupling 22 used for joining together the adjacent ends of two molding sections that meet at an outside corner.

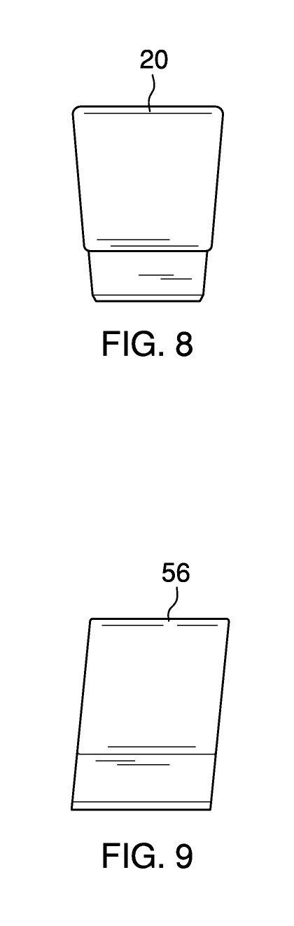

In FIG. 8 there is illustrated a straight coupling 20 used for joining together the confronting ends of two molding sections that are attached along a common wall surface.

In FIG. 9 there is illustrated an end cap 56 used for terminating an end of a molding section such that terminated end is provided with a finished, decorative appearance.

Couplings 20, 22, 24 and 56 are designed to be snapped or clipped over the surface of the molding sections such that the ends of the molding sections are received by the couplings. One of ordinary skill in the art will readily appreciate this connecting structure without providing additional details herein. Couplings 20, 22, 24 and 56 may be made from the same material as the molding sections and have the same finish so as to bend into and form a continuous structure. Alternatively, couplings 20, 22, 24 and 56 may have a decorative patterned finish so as to provide a more complex decorative appearance to the structure.

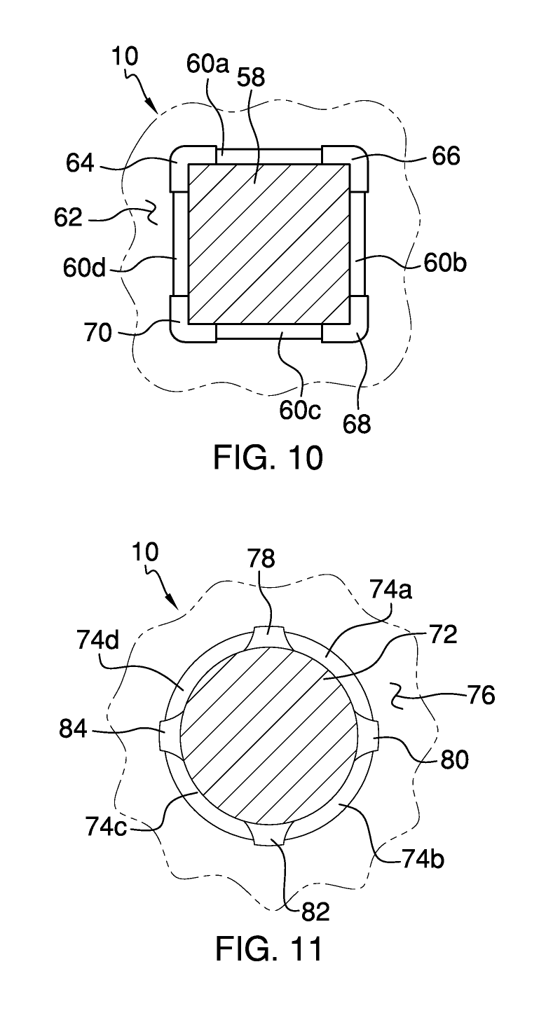

In FIG. 10, there is illustrated an application of the architectural molding system 10 with a rectangular shaped support column 58. In this application, molding sections 60a-d are mounted to each vertical wall of the support column along the joint with floor surface 62. Outside corner coupling 64 joins together the ends of molding sections 60a and 60d, outside corner coupling 66 joins together the ends of molding sections 60a and 60b, outside corner coupling 68 joins together the ends of molding sections 60b and 60c, and outside corner coupling 70 joins together the ends of molding sections 60c and 60d.

In FIG. 11, there is illustrated an application of the architectural molding system 10 with a circular shaped support column 72. In this application, molding sections 74a-d are mounted to and are curved around vertical wall of the support column along the joint with floor surface 76. Straight coupling 78 joins together the ends of molding sections 74a and 74d, straight coupling 12′ joins together the ends of molding sections 74a and 74b, straight coupling 82 joins together the ends of molding sections 74b and 74c, and straight coupling 84 joins together the ends of molding sections 74c and 74d.

Other embodiments of the architectural molding system 10 while remaining within the scope of the present invention. For example, molding sections may be made of translucent or semi-transparent materials to allow some light from the illuminated rope light(s) to pass through the molding section itself, thus providing additional illumination and an alternative lighting effect. Additionally, the front side 34 of the molding sections can have many different configurations to match or compliment the décor and personal preference.

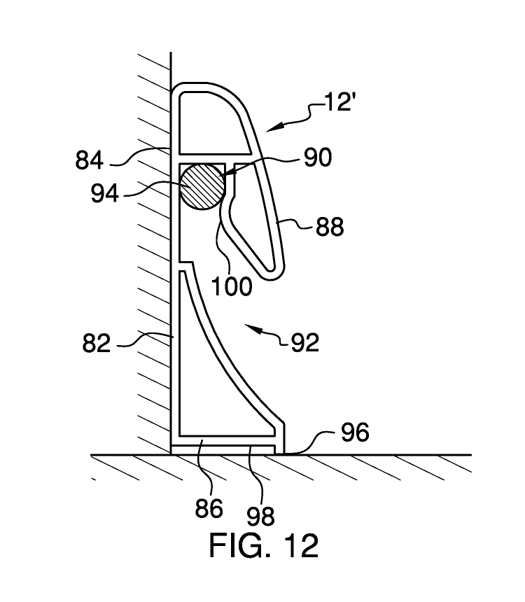

With reference to FIG. 12, there is representatively illustrated a cross-section of a molding section 12′ in accordance with an alternative embodiment of the present invention. Molding section 12′ may be substituted for molding sections 12 of system 10 and comprises an elongated body 82. Body 82 includes a vertically extending back surface or wall 84, a bottom surface or wall 86, and a decorative front surface or wall 88.

The back wall 84 is substantially flat to interface with wall 14, and may be textured to permit better bonding with an adhesive used to mount body 82 to the wall. The bottom surface 86 extending forwardly from the back wall and forms a 90-degree angle therewith permitting the molding section to be placed along the interface edge between a wall and floor surface with the back wall adjacent the wall surface and the bottom wall adjacent the floor surface. The decorative front surface 88 may be configured to have any desirable decorative design. Here front surface 88 is shown to be simple in form and includes a downwardly sloped with a smooth surface.

Body 82 further includes a longitudinally extending rope light clip channel 90 configured to receive a rope light 94 or the like therein and a longitudinally extending slot 92 formed through the front surface 88 and communicating with the rope light clip channel 90, through which a length of rope light may be passed to be received and retained by the rope light channel.

Longitudinally extending slot 92 is downwardly and outwardly sloped providing a light communicating pathway from which light emitted from the rope light 94 may pass to be projected upon and illuminate a floor surface area approximate the molding 12′.

Body 82 may further include a longitudinally extending lip or leg 96 that downwardly depends from the bottom wall 86 at its forward edge opposite from the back wall 84. Leg 96 serves to elevate the bottom wall 86 slightly above a floor surface to provide a small longitudinally extending gap 98 between the floor surface and the bottom wall. Gap 98 may serve several purposes including providing a weep passage or a space for adhesive between the bottom wall 86 and a floor surface.

Body 82 may further include a projection 100 that extends inwardly into and longitudinally along the rope light clip channel 90. Projection 100 narrows an opening into the rope light clip channel 90 and serves to retain a rope light within the channel.

Further, while the main focus of the above description was made in connection with the architectural molding system 10 being implemented in a baseboard configuration, it is important to realize the system may be implemented in a crown molding configuration and remain within the scope of the invention.

Additionally, it is contemplated that other light sources could also be used. For example, a fiber optic light source can be run through either of the upper and lower rope light clip channels 30 and 32. It is known, that a fiber optic system may allow the light to change color according to user preference. Of course an LED equipped rope light could also provide the change color effect.

A number of embodiments of the present invention have been described.

Nevertheless, it will be understood that various modifications may be made without departing from the spirit and scope of the invention. Accordingly, other embodiments are within the scope of the following claims.

What is claimed is:

1. An architectural molding system, comprising:
at least one section of molding, said at least one section of molding having an elongated body including a longitudinally extending light clip channel and a longitudinally extending slot through a front surface of said elongated body and communicating with said longitudinally extending light clip channel, said longitudinally extending slot being downwardly and outwardly sloped in a direction from said longitudinally extending light clip channel towards the bottom of said front surface.

2. The architectural molding system of claim 1, wherein said elongated body further includes a back wall and a bottom wall extending forwardly from said back wall.

3. The architectural molding system of claim 2, wherein said back wall and said bottom wall define a 90-degree angle so as to permit placement of said elongated body along the interface edge of a wall and floor surface.

4. The architectural molding system of claim 1, wherein said at least one section of molding is baseboard.

5. The architectural molding system of claim 1, wherein said body further includes a back wall, a bottom wall forwardly extending from said back wall, and a leg downwardly depending from said bottom wall at an edge thereof that is opposite of said back wall.

6. The architectural molding system of claim 1, wherein said body further includes a semi-circular projection extending inwardly into and continuously along the rope light clip channel that serves to narrow said rope light clip channel.

7. The architectural molding system of claim 1, wherein said body further includes a second longitudinally extending rope light clip channel, said second longitudinally extending rope light clip channel being rearwardly open relative to said front surface.

8. The architectural molding system of claim 1, wherein said at least one section of molding further includes a paver channel connected to a rearward side of said body.

9. An architectural molding system comprising:
at least one section of molding, said at least one section of molding having an elongated body including a substantially flat back wall, a substantially flat bottom wall joined to said back wall and extending forwardly from said back wall, a decorative front surface, a longitudinally extending light clip channel and a longitudinally extending slot through said front surface and communicating with said longitudinally extending light clip channel;
said longitudinally extending slot being downwardly and outwardly sloped in a direction from said longitudinally extending light clip channel towards said front surface; and
a flexible light source disposed within said longitudinally extending light clip channel.

10. The architectural molding system of claim 9, wherein said body further includes a semi-circular projection extending inwardly into and continuously along the rope light clip channel that serves to narrow said rope light clip channel.

11. The architectural molding system of claim 9, wherein said at least one molding is baseboard.

12. The architectural molding system of claim 9, wherein said body further includes a leg downwardly depending from said bottom wall at an edge thereof that is opposite of said back wall.

13. The architectural molding system of claim 9, wherein said back wall and said bottom wall define a 90-degree angle so as to permit placement of said elongated body along the interface edge of a wall and floor surface.

14. An architectural molding system comprising:
a plurality of molding sections inter-connected end-to-end and extending along an interface edge between a wall surface and a floor surface;
each of said molding sections comprising an elongated body including a longitudinally extending light clip channel and a longitudinally extending slot through a front surface of said elongated body and communicating with said longitudinally extending light clip channel, said longitudinally extending slot being downwardly and outwardly sloped in a direction from said longitudinally extending light clip channel towards the bottom of said front surface; and
a flexible light source disposed within said longitudinally extending light clip channel of each molding section.

15. The architectural molding system of claim 14, wherein said body further includes a semi-circular projection extending inwardly into and continuously along the rope light clip channel that serves to narrow said rope light clip channel.

16. The architectural molding system of claim 15, wherein said body further includes a back wall, a bottom wall forwardly extending from said back wall, and a leg downwardly depending from said bottom wall at an edge thereof that is opposite of said back wall.

17. The architectural molding system of claim 16, wherein said back wall and said bottom wall define a 90-degree angle so as to permit placement of said elongated body along the interface edge of said wall surface and said floor surface.

18. The architectural molding system of claim 14, wherein said body further includes a second longitudinally extending rope light clip channel, said second longitudinally extending rope light clip channel being rearwardly open relative to said front surface.

19. The architectural molding system of claim 14, wherein said at least one section of molding further includes a paver channel connected to a rearward side of said body.
